(19) United States
(12) Patent Application Publication
(10) Pub. No.: US 2009/0020141 A1
(43) Pub. Date: Jan. 22, 2009

(54) FLOOR CARE APPARATUS WITH PHOTOELECTRIC QUASI-AUTOMATIC HEIGHT ADJUSTMENT

(76) Inventor: Kerry L. Dever, Lexington, KY (US)

Correspondence Address: KING & SCHICKLI, PLLC, 247 NORTH BROADWAY, LEXINGTON, KY, 40507, US

(21) Appl. No.: 11/780,232

(22) Filed: Jul. 19, 2007

(51) Int. Cl. B08B 5/04; A47L 9/10; B08B 7/04

(52) U.S. Cl. 134/18; 15/347

(57) ABSTRACT

A floor care apparatus includes a nozzle assembly having suction inlet. A canister assembly is connected to the nozzle assembly. A suction generator and a dirt collection vessel are carried on one of the nozzle assembly and canister assembly. A height adjustment mechanism is carried on the nozzle assembly. In addition a photo sensor unit is carried on the nozzle assembly for sensing the height of the nap of an underlying carpet or rug being cleaned. The height adjustment mechanism and the photo sensor unit cooperate together to allow the operator to automatically adjust the operating height of the vacuum cleaner relative to the height of the nap of the carpet being cleaned.

### TECHNICAL FIELD

The present invention relates generally to the floor care appliance field and, more particularly, to a floor care apparatus incorporating a photoelectric quasi-automatic height adjustment mechanism.

### BACKGROUND OF THE INVENTION

Floor care apparatus such as vacuum cleaners are utilized to clean many different floor surfaces. There are a broad range of bare floor surfaces made from many different materials including, but not limited to, concrete, hardwood, linoleum and tile. Of course, many floors are covered with rugs or carpeting. The height of the pile of different carpets and rugs may vary significantly. In order to maximize the cleaning efficiency of the vacuum cleaner, it is known to vary the height of the nozzle assembly above the surface to be cleaned in order to provide proper suction and flow path and to position the rotary agitator at the proper height to agitate the dirt on the surface.

One system for varying the height of the nozzle assembly of a vacuum cleaner is disclosed in U.S. Pat. No. 4,342,132 to Fromnecht. This patent discloses a mechanical system for sensing the carpet pile height and adjusting the height of the nozzle assembly. The device includes a pile height and density sensor plate that is journalled to an axle carried on a nozzle assembly. The plate or foot may be formed from sheet metal with a generally arcuate smoothly rounded toe portion so that the plate or foot may ride smoothly on top of the floor covering pile. The plate or foot is connected by a cable to an indicator slide that automatically indicates the appropriate nozzle height position for any specific floor covering upon which the cleaner is positioned.

The present invention relates to a new and improved height adjustment mechanism that relies upon an electronic sensor instead of a mechanical sensor and further incorporates a mechanism for automatically adjusting the height of the nozzle assembly in response to user input.

### SUMMARY OF THE INVENTION

In accordance with the purposes of the present invention as described herein, a floor care apparatus is provided comprising a nozzle assembly including a suction inlet, a canister assembly connected to the nozzle assembly, a suction generator carried on one of the nozzle assembly and the canister assembly, a dirt collection vessel carried on one of the nozzle assembly and the canister assembly, a height adjustment mechanism carried on the nozzle assembly and a photo sensor unit carried on the nozzle assembly for sensing height of the nap of an underlying carpet or rug being cleaned.

In one possible embodiment of the present invention, the photo sensor unit includes a first sensor element including a first light emitter and a cooperating first light receiver, a second sensor element including a second light emitter and a cooperating second light receiver and a third sensor element including a third light emitter and a third cooperating light receiver. Further, a channel is provided in the nozzle assembly. The channel includes a first sidewall, a second sidewall and an open bottom. The first sensor element is provided on the first and second sidewalls a distance D₁ from the open bottom of the channel. The second sensor element is provided on the first and second sidewalls a distance D₂ from the open bottom of the channel. The third sensor element is provided on the first and second sidewalls a distance D₃ from the open bottom of the channel. The distance D₁ is less than the distance D₂, which is less than the distance D₃.

The first, second and third light emitters are carried on the first sidewall and the first, second and third light receivers are carried on the second sidewall of the channel. The photo sensor unit further includes a controller and a control actuator. The controller is connected to the first, second and third sensor units.

In addition, the height adjustment mechanism includes a motor, a chassis and a height adjustment wheel carried on the chassis. The controller is connected to the motor. The motor includes a threaded drive shaft and the chassis includes a thread block engaging the drive shaft whereby the motor operates to displace the height adjustment wheel and raise or lower the nozzle assembly with respect to the floor being cleaned.

In accordance with additional aspects of the present invention, in one possible embodiment the canister assembly is pivotally connected to the nozzle assembly. Further, the dirt collection vessel is a dirt cup. That dirt cup may include a cylindrical sidewall, a tangentially directed inlet and an axially directed outlet. A filter may be provided in the dirt cup covering the axially directed outlet. Further, the floor care apparatus may include a rotary agitator carried on the nozzle assembly adjacent the suction inlet.

In accordance with yet an additional aspect of the present invention a floor care apparatus is provided comprising a nozzle assembly including a suction inlet, a canister assembly connected to the nozzle assembly as well as a suction generator, a dirt collection vessel, a sensor unit and a height adjustment mechanism. The sensor unit is carried on the nozzle assembly for sensing the height of the nap of an underlying carpet or rug being cleaned. The height adjustment mechanism is carried on the nozzle assembly and includes a motor, a chassis and a height adjustment wheel carried on the chassis. The motor includes a threaded drive shaft and the chassis includes a thread block engaging the drive shaft. The motor operates to displace the height adjustment wheel and raise or lower the nozzle assembly with respect to the floor being cleaned.

In accordance with yet another aspect of the present invention a floor care apparatus is provided comprising a nozzle assembly including a suction inlet, a canister assembly connected to the nozzle assembly, a suction generator, a dirt collection vessel and a means for adjusting the height of the nozzle assembly. The height adjusting means includes a nap sensor, an adjustable height wheel and a controller wherein the controller adjusts the height of the adjustable height wheel in response to the nap sensor. The floor care apparatus may further include a control actuator connected to the controller.

In accordance with yet another aspect of the present invention, a method is provided for adjusting an operating height of a nozzle assembly of a floor care apparatus. The method comprises the steps of providing the floor care apparatus with a control actuator which is used by an operator to select an operating height for the floor care apparatus, sensing the height of a carpet nap being cleaned with a nap sensor and adjusting the height of the nozzle assembly above the floor in response to the selected operating height and the sensed height of the carpet nap.

In the following description there is shown and described a preferred embodiment of this invention, simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain certain principles of the invention. In the drawings:

FIG. 1 is a perspective, partially cut-away view of the floor cleaning apparatus of the present invention;

FIG. 1a is a schematical illustration of one possible embodiment of the dirt collection vessel provided on the vacuum cleaner;

FIG. 2 is a schematical illustration of the height adjustment mechanism and photo sensor unit provided on the floor care apparatus of the present invention;

FIGS. 3a and 3b are schematical illustrations illustrating how the floor cleaning apparatus is lowered into the low height cleaning position for proper cleaning of a short pile carpet;

FIGS. 4a and 4b schematically illustrate how the floor care apparatus is raised to an intermediate height position from the low position;

FIGS. 5a and 5b schematically illustrate how the floor care apparatus is lowered from the high position to the medium height cleaning position; and

FIGS. 6a and 6b schematically illustrate how the floor care apparatus is raised to the high height position.

Reference will now be made in detail to the present preferred embodiment of the invention, an example of which is illustrated in the accompanying drawings.

### DETAILED DESCRIPTION OF THE INVENTION

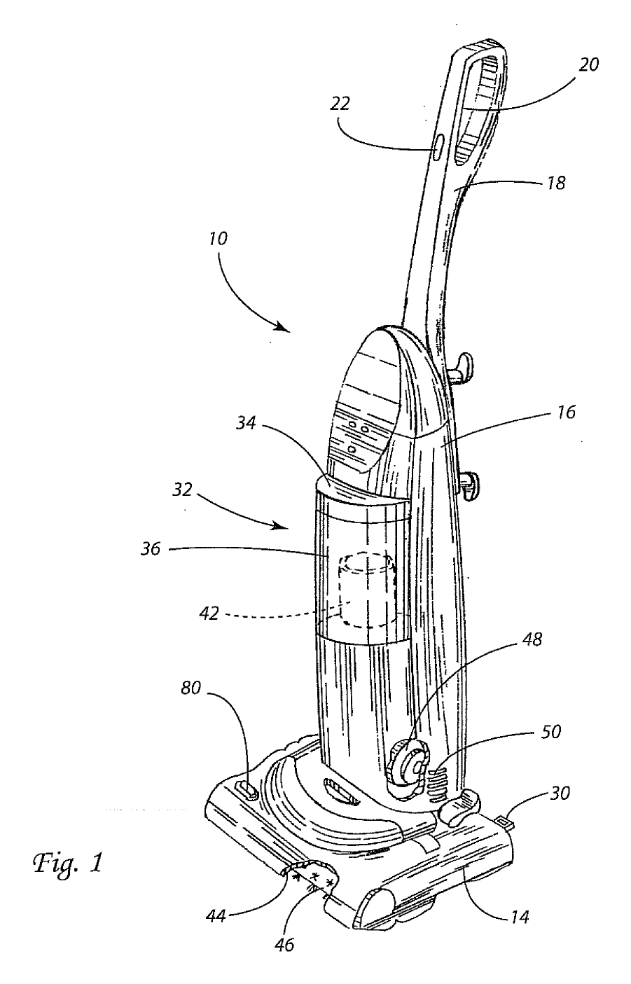

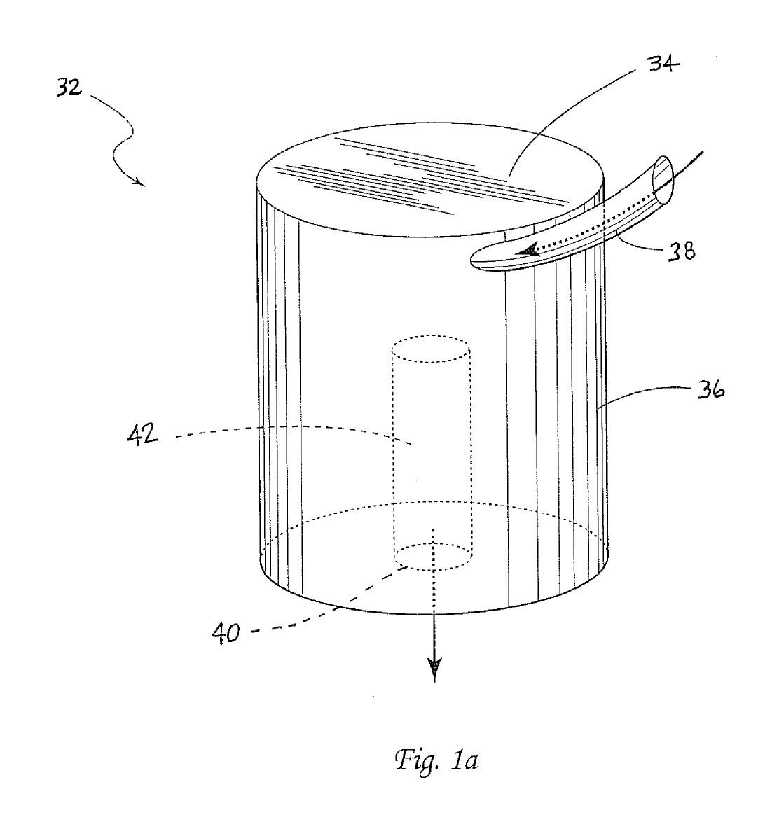

Reference is now made to FIG. 1 showing the floor care apparatus of the present invention in the form of an upright vacuum cleaner 10. The upright vacuum cleaner 10 includes a housing comprising a first section or nozzle assembly 14 and a second section or canister assembly 16. The canister assembly 16 includes a control handle 18 and a handgrip 20. A control switch 22 is provided adjacent the handgrip 20 for turning the vacuum cleaner 10 on and off. Electrical power is supplied to the vacuum cleaner 10 from a standard electrical wall outlet through an electrical power cord 24 (not shown).

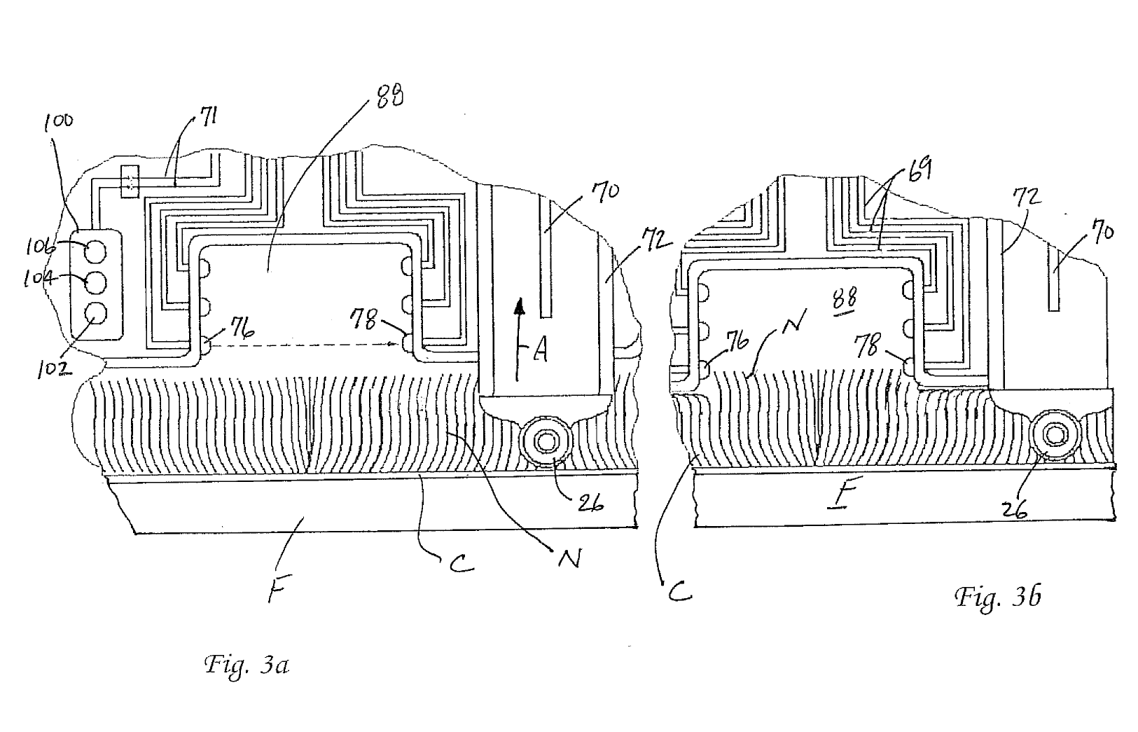

A pair of rear wheels (not shown) are provided on the lower portion of the canister assembly 16 and a pair of front wheels 26 (one shown in FIG. 3) are provided on the nozzle assembly 14. Together, these wheels 26 support the vacuum cleaner 10 for movement across the floor. To allow for convenient storage of the vacuum cleaner 10, a foot latch 30 functions to lock the canister assembly 16 in an upright position as shown in FIG. 1. When the foot latch 30 is released, the canister assembly 16 may be pivoted relative to the nozzle assembly 14 as the vacuum cleaner 10 is manipulated back and forth to clean the floor.

In the presently illustrated embodiment, the canister assembly 16 includes a cavity adapted to receive and hold the dirt collection vessel 32. As illustrated in FIG. 1a, the dirt collection vessel 32 may take the form of a dirt cup 34 including a substantially cylindrical sidewall 36, a tangentially directed inlet 38 and an axially directed outlet 40. A primary filter 42 may be provided in the dirt cup 34 over the axially directed outlet 40. The primary filter 42 is cylindrical in shape and concentrically received within the cylindrical sidewall 36 of the dirt cup 34. Such a structural arrangement induces cyclonic airflow in the dirt cup 34 and provides for enhanced cleaning efficiency. In an alternative design, the canister assembly 16 includes a closed compartment that houses a filter or vacuum cleaner bag, of a type known in the art, that functions as the dirt collection vessel 32.

The nozzle assembly 14 includes a suction inlet 44. A rotary agitator 46 is carried on the nozzle assembly 14 so as to extend across the suction inlet 44. A suction generator 48, including a fan and a cooperating drive motor, is carried on the canister assembly 16. The suction generator 48 functions to generate a vacuum air stream for drawing dirt and debris from the surface to be cleaned. The rotary agitator 46 may be connected by a power take off to the motor of the suction generator 48. Alternatively, the rotary agitator 46 may be powered by a dedicated drive motor.

During normal vacuum cleaner operation, the rotary agitator 46 is driven by the motor of the suction generator 48 and functions to beat dirt and debris from the nap of an underlying carpet. The suction generator 48 functions to draw a vacuum air stream into the suction inlet 44. Dirt and debris from the carpet is entrained in the air stream, which is then drawn by the suction generator 48 into the dirt cup 34. Dirt and debris is captured in the dirt cup 34 while relatively clean air is drawn through the primary filter 42. That air stream passes over the motor of the suction generator 48 to provide cooling before being exhausted through a final filter, such as a HEPA filter (not shown), before being exhausted through an exhaust port 50 into the environment.

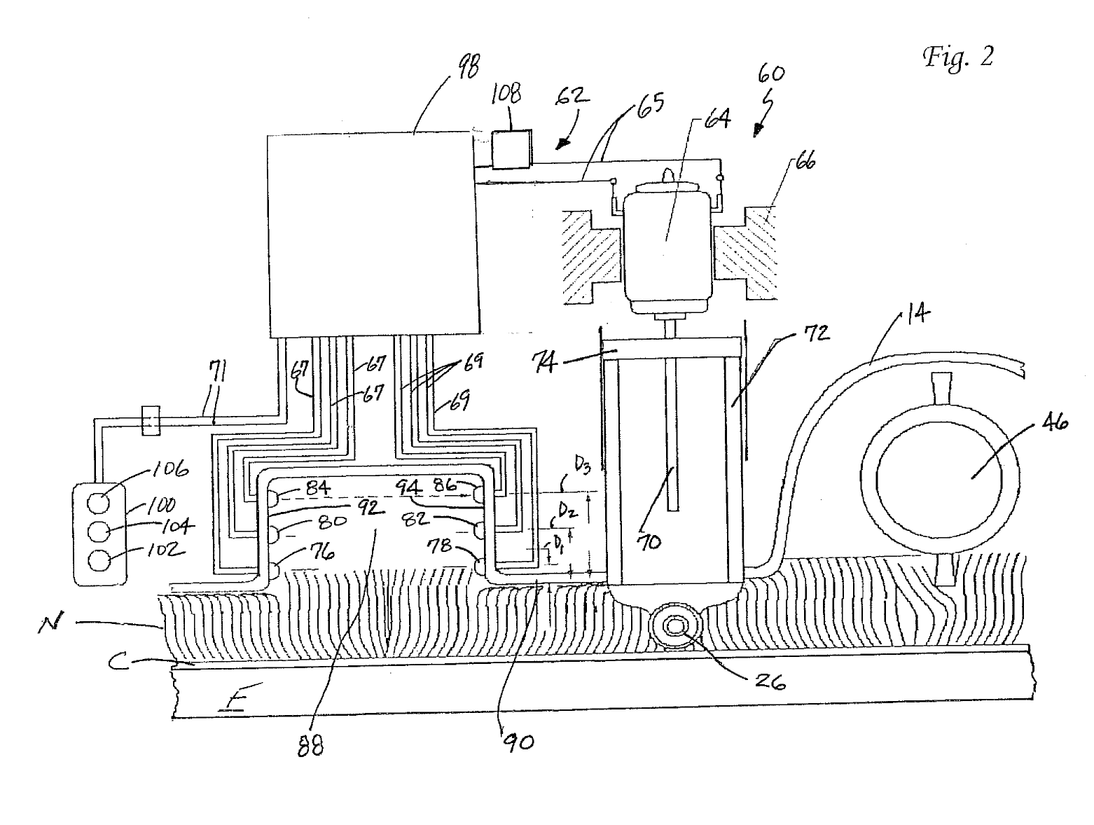

As schematically illustrated in FIG. 2, the upright vacuum cleaner 10 is equipped with a height adjustment mechanism, generally designated by reference numeral 60 and a photo sensor unit, generally designated by reference numeral 62. As illustrated, the height adjustment mechanism 60 includes a motor 64 held in a motor mount 66 that is secured to the nozzle assembly 14. The motor 64 includes a threaded drive shaft 70. A chassis 72 is connected to the threaded drive shaft 70 by means of a thread block 74. The thread block 74 and chassis 72 are received in a channel of the nozzle assembly 14 that allows for free sliding movement but prevents the block and chassis from rotating with the drive shaft 70. The two height adjustment wheels 26 (only one shown in the Figure) are carried on the chassis 72 and ride over the floor F being cleaned. As a result of this arrangement, the chassis 72 may be moved up and down the threaded drive shaft 70 in order to raise and lower the operating height of the vacuum cleaner 10.

The photo sensor unit 62 includes a first sensor element comprising a first light emitter 76 and a cooperating first light receiver 78, a second sensor element comprising a second light emitter 80 and a cooperating second light receiver 82 and a third sensor element comprising a third light emitter 84 and a cooperating third light receiver 86. A channel 88 is provided in the bottom wall 90 of the nozzle assembly 14. The channel 88 includes a first sidewall 92, a second wall 94 and an open bottom. The first, second and third light emitters 76, 80 and 84 are mounted in the first sidewall 92 while the first, second and third light receivers 78, 82 and 86 are mounted in the second sidewall 94. The first light emitter 76 is provided directly across from and aligned with the first light receiver 78. The second light emitter 80 is provided directly across from and aligned with the second light receiver 82. The third light emitter 84 is provided directly across from and aligned with the third light receiver 86.

As illustrated, the first sensor element including the first light emitter 76 and the first light receiver 78 is provided a distance D₁ from the bottom wall 90 of the nozzle assembly 14 or the open bottom of the channel 88. The second sensor element including the second light emitter 80 and second light receiver 82 is provided a distance D₂ from the bottom wall 90 and open bottom of the channel 88. The third sensor element including the third light emitter 84 and the third light receiver 86 is provided a distance D₃ from the bottom wall 90 and open bottom of the channel 88. As illustrated the distance D₁ is less than the distance D₂ which is less than the distance D₃ so that the three sensor elements are vertically spaced between the open bottom and the top wall 96 of the channel 88.

The photo sensor unit 62 also includes a controller 98. The controller 98 is connected to the motor 64 by the controls lines 65 and a relay 108, the first, second and third light emitters 76, 80, 84 by the control lines 67, the first, second and third light receivers 78, 82, 86 by the control lines 69 and a control actuator 100 by the control line 71. In the illustrated embodiment the control actuator 100 comprises a push button controller with three control buttons 102, 104, 106.

Operation of the height adjustment mechanism 60 and photo sensor unit 62 will now be described in detail with reference to FIGS. 3a, 3b, 4a, 4b, 5a, 5b, 6a and 6b. FIGS. 3a and 3b illustrate how the upright vacuum cleaner 10 is lowered from the first position shown in FIG. 3a to the lowermost cleaning position illustrated in FIG. 3b. Initially, the operator selects the lowermost cleaning height by pushing the control button 102 on the control actuator 100. As illustrated in FIG. 3a, a clear path exists for light to travel from the first light emitter 76 to the first light receiver 78. As a result, the first sensor element 76, 78 generates a closed signal. In response to the closed signal, the controller 98 closes the relay and energizes the height adjustment motor 64. The height adjustment motor 64 rotates the threaded drive shaft 70 that is engaged by the thread block 74 carried on the chassis 72. As the drive shaft 70 rotates, the chassis 72 moves in the direction of action arrow A thereby lowering the vacuum cleaner 10 toward the floor F being cleaned until the nap end N of the carpet C interrupts the light path between the first light emitter 76 and the first light receiver 78. In response to the interruption, the controller 98 opens the relay 108 and the height adjustment motor 64 is de-energized stopping the vacuum cleaner 10 at the low cleaning position.

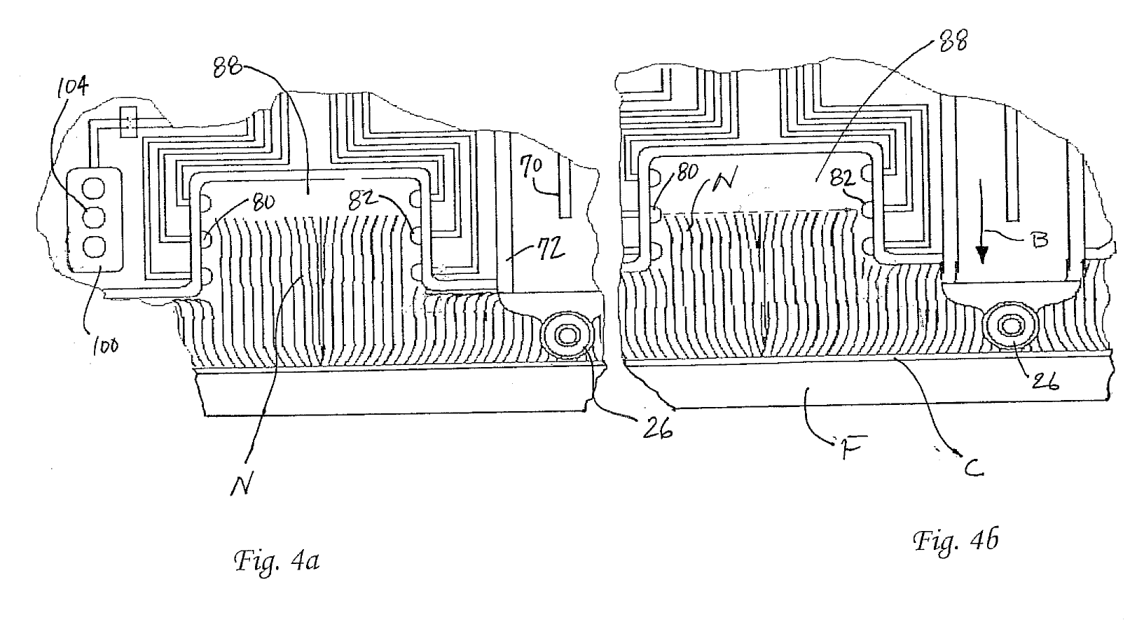

FIGS. 4a and 4b illustrate how the upright vacuum cleaner 10 is brought to an intermediate height cleaning position (illustrated in FIG. 4b) from a lower height cleaning position (illustrated in FIG. 4a). More specifically, the operator selects the medium height setting by depressing the second or medium height control button 104 on the control actuator 100. An open signal is generated between the second or medium height sensor element including the second light emitter 80 and the second light receiver 82. In response the controller 98 closes the relay 108. This serves to energize the height adjust motor 64 which, in turn, rotates the drive shaft 70 so as to cause the upright vacuum cleaner to be raised relative to the floor F (see action arrow B showing direction of movement of chassis 72 along the drive shaft 70). When the second light emitter 80 and second light receiver 82 rise above the top of the nap end N of the carpet C, a closed signal is detected and the controller 98 opens the relay 108 thereby de-energizing the motor 64. As a consequence, the upright vacuum cleaner is adjusted to and held in the intermediate height cleaning position illustrated in FIG. 4b.

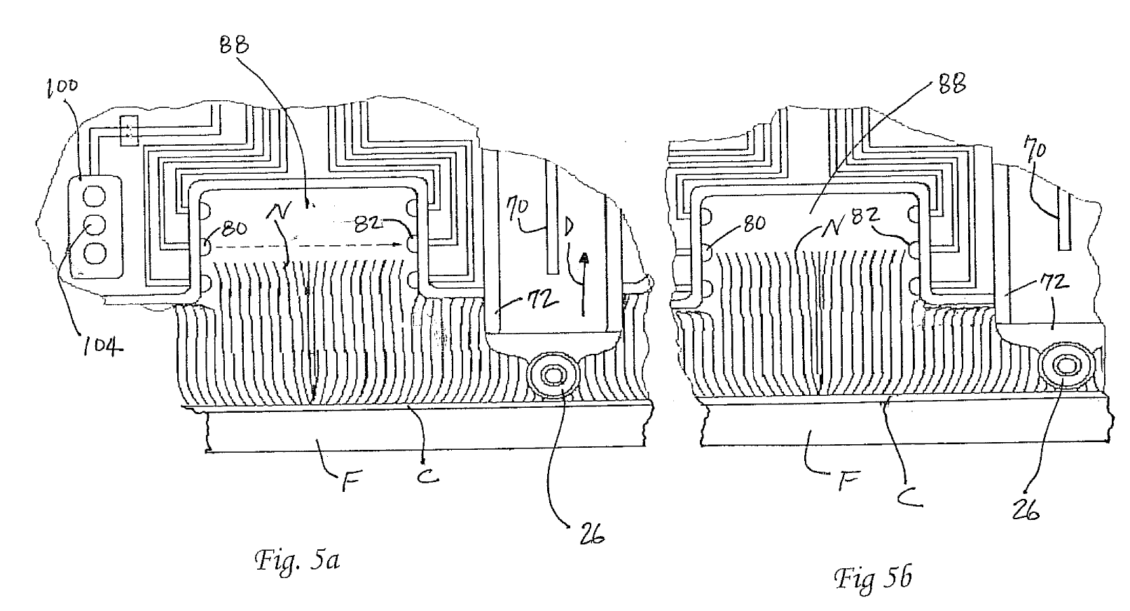

FIGS. 5a and 5b illustrate how the upright vacuum cleaner is adjusted to an intermediate height cleaning position (illustrated in FIG. 5b) from a higher height cleaning position (illustrated in FIG. 5a). Again, the operator initially depresses the second or intermediate height control button 104 on the control actuator 100. A closed signal is generated between the second light emitter 80 and second light receiver 82 of the second or intermediate sensor element. The controller 98 closes the relay 108 energizing the height adjust motor 64. The motor 64 rotates the threaded drive shaft 70. The thread block 74 secured to the chassis 72 moves along the threaded drive shaft 70 so that the chassis moves in the direction of action arrow D thereby lowering the height of the upright vacuum cleaner 10. As the upright vacuum cleaner 10 is lowered, the top of the nap N of the carpet C interrupts the light path between the second light emitter 80 and second light receiver 82. The controller 98 responds to this interruption of the signal by opening the relay 108 and thereby de-energizing the motor 64. As a consequence the upright vacuum cleaner 10 is moved into the intermediate height cleaning position as illustrated in FIG. 5b.

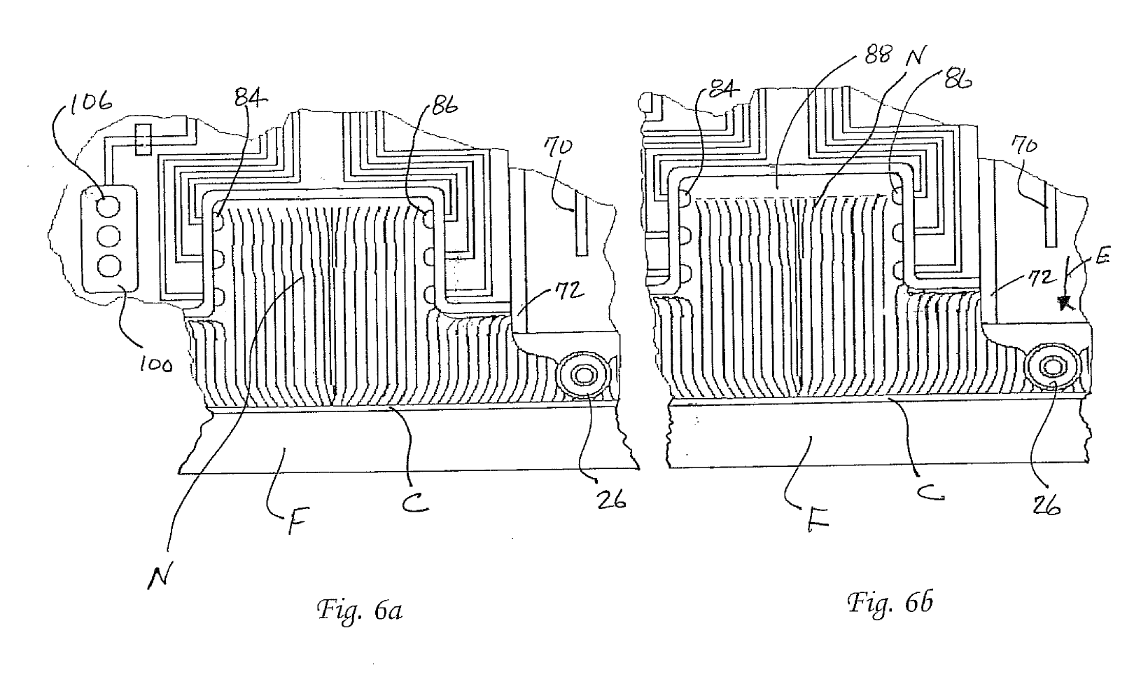

FIGS. 6a and 6b illustrate how the upright vacuum cleaner 10 is moved to the highest height cleaning position (illustrated in FIG. 6b) from a lower position (illustrated in FIG. 6a). More specifically, the operator selects the highest height cleaning setting by depressing the third control button 106 on the control actuator 100. As illustrated in FIG. 6a, the nap end of the carpet C lays in the light path between the third light emitter 84 and the third light receiver 86 of the third sensor. Accordingly, an open signal is detected. In response, the controller 98 closes the relay 108 thereby energizing the height adjust motor 64. The height adjust motor 64 rotates the threaded drive shaft 70 that is engaged by the thread block 74 on the chassis 72 carrying the height adjustment wheels 26. As the drive shaft 70 is rotated, the chassis 72 and, therefore, the connected height adjustment wheels 26 are moved in the direction of action arrow E (see FIG. 6b) thereby raising the vacuum cleaner 10. At some point during the raising operation the third light emitter 84 and third light receiver 86 clear the top of the nap N of the carpet C resulting in a closed signal. In response the controller 98 opens the relay 108 thereby de-energizing the motor 64 with the upright vacuum cleaner 10 in the highest height adjustment position illustrated in FIG. 6b.

In summary, numerous benefits result from employing the concepts of the present invention. The control actuator 100 allows the operator to select the desired operating height for the vacuum cleaner 10. The photo sensor unit 62 and height adjustment mechanism 60 then work in cooperation to automatically adjust the height of the vacuum cleaner 10 in response to the operator input through the control buttons 102, 104, 106 and the detected height of the nap N of the carpet C that is being cleaned. The present invention allows the operator to quickly and efficiently adjust the operating height of the vacuum cleaner 10 in order to optimize the cleaning efficiency of the vacuum cleaner in a simple, convenient and automatic manner.

The foregoing description of the preferred embodiments of the present invention have been presented for purposes of illustration and description. It is not intended to be exhaustive or to limit the invention to the precise form disclosed. Obvious modifications or variations are possible in light of the above teachings. For example, while the floor care apparatus illustrated is an upright vacuum cleaner, it may also take the form of a canister vacuum cleaner or even an extractor. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

The foregoing description of the preferred embodiments of the present invention have been presented for purposes of illustration and description. It is not intended to be exhaustive or to limit the invention to the precise form disclosed. Obvious modifications or variations are possible in light of the above teachings. For example, while the floor care apparatus illustrated is an upright vacuum cleaner, it may also take the form of a canister vacuum cleaner or even an extractor. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A floor care apparatus, comprising:
a nozzle assembly including a suction inlet;
a canister assembly connected to said nozzle assembly;
a suction generator carried on one of said nozzle assembly and said canister assembly;
a dirt collection vessel carried on one of said nozzle assembly and said canister assembly;
a height adjustment mechanism carried on said nozzle assembly; and
a photo sensor unit carried on said nozzle assembly for sensing height of nap of an underlying carpet or rug being cleaned.

2. The floor care apparatus of claim 1, wherein said photosensor unit include a first sensor element including a first light emitter and a cooperating first light receiver, a second sensor element including a second light emitter and a cooperating second light receiver and a third sensor element including a third light emitter and a third cooperating light receiver.

3. The floor care apparatus of claim 2, including a channel provided in said nozzle assembly wherein said channel has a first sidewall, a second sidewall and an open bottom.

4. The floor care apparatus of claim 3, wherein said first sensor element is provided on said first and second sidewalls a distance D₁ from said open bottom of said channel, said second sensor element is provided on said first and second sidewalls a distance D₂ from said open bottom of said channel and said third sensor element is provided on said first and second sidewalls a distance D₃ from said open bottom of said channel wherein D₁<D₂<D₃.

5. The floor care apparatus of claim 4, wherein said first, second and third light emitters are carried on said first sidewall and said first, second and third light receivers are carried on said second sidewall.

6. The floor care apparatus of claim 5, wherein said photosensor unit includes a controller connected to said first, second and third sensor elements.

7. The floor care apparatus of claim 5, wherein said photosensor unit includes a control actuator.

8. The floor care apparatus of claim 7, wherein said height adjustment mechanism includes a motor, a chassis and a height adjustment wheel carried on said chassis.

9. The floor care apparatus of claim 8, wherein said controller is connected to said motor.

10. The floor care apparatus of claim 9, wherein said motor includes a threaded drive shaft and said chassis includes a thread block engaging said drive shaft whereby said motor operates to displace said height adjustment wheel and raise or lower said nozzle assembly with respect to a floor being cleaned.

11. The floor care apparatus of claim 1, wherein said canister assembly is pivotally connected to said nozzle assembly.

12. The floor care apparatus of claim 1, wherein said dirt collection vessel is a dirt cup.

13. The floor care apparatus of claim 12, wherein said dirt cup includes a cylindrical sidewall, a tangentially directed inlet and an axially directed outlet.

14. The floor care apparatus of claim 13, wherein a filter is provided in said dirt cup covering said axially directed outlet.

15. The floor care apparatus of claim 1, further including a rotary agitator carried on said nozzle assembly adjacent said suction inlet.

16. A floor care apparatus, comprising:
a nozzle assembly including a suction inlet;
a canister assembly connected to said nozzle assembly;
a suction generator carried on one of said nozzle assembly and said canister assembly;
a dirt collection vessel carried on one of said nozzle assembly and said canister assembly;
a sensor unit carried on said nozzle assembly for sensing height of nap of an underlying carpet or rug being cleaned; and
a height adjustment mechanism carried on said nozzle assembly, said height adjustment mechanism including a motor, a chassis and a height adjustment wheel carried on said chassis.

17. The floor care apparatus of claim 16, wherein said motor includes a threaded drive shaft and said chassis includes a thread block engaging said drive shaft whereby said motor operates to displace said height adjustment wheel and raise or lower said nozzle assembly with respect to a floor being cleaned.

18. A floor care apparatus, comprising:
a nozzle assembly including a suction inlet;
a canister assembly connected to said nozzle assembly;
a suction generator carried on one of said nozzle assembly and said canister assembly;
a dirt collection vessel carried on one of said nozzle assembly and said canister assembly; and
means for adjusting height of said nozzle assembly including a nap sensor, an adjustable height wheel and a controller wherein said controller adjusts the height of said adjustable height wheel in response to said nap sensor.

19. The floor care apparatus of claim 18 further including a control actuator connected to said controller.

20. A method of adjusting an operating height of a nozzle assembly of a floor care apparatus, comprising:
providing said floor care apparatus with a control activator which is used by an operator to select an operating height for said floor care apparatus;
sensing height of a carpet nap being cleaned with a nap sensor; and
adjusting height of said nozzle assembly above said floor in response to said selected operating height and said sensed height of said carpet nap.
